(19) United States
(12) Patent Application Publication
(10) Pub. No.: US 2025/0199029 A1
(43) Pub. Date: Jun. 19, 2025

(54) METHOD FOR PRODUCING AN INERTIAL SENSOR SYSTEM AND INERTIAL SENSOR SYSTEM PRODUCED USING THE METHOD

(71) Applicant: Fraunhofer-Gesellschaft zur Förderung der Angewandten Forschung E.V., München (DE)

(72) Inventors: UWE SCHEITHAUER, Dresden (DE); Lars REBENKLAU, Dresden (DE); Daniel BÜLZ, Chemnitz (DE); Roman FORKE, Chemnitz (DE)

(21) Appl. No.: 18/978,913

(22) Filed: Dec. 12, 2024

(30) Foreign Application Priority Data
Dec. 14, 2023 (DE) 10 2023 212 700.8

(51) Int. Cl. G01P 15/08; B33Y 10/00; B33Y 40/20; B33Y 70/10; B33Y 80/00; G01C 19/5783

(52) U.S. Cl. CPC G01P 15/0802; B33Y 80/00; G01C 19/5783; B33Y 10/00; B33Y 40/20; B33Y 70/10

(57) ABSTRACT

A sensor system is made up of a hermetically sealed housing, which is formed with a base plate, a carrier structure arranged in the interior of the housing, and a cover element, made of the same ceramic material. One or more sensor units are arranged on each of a plurality of walls of the carrier structure, the base plate and/or the cover element. The cover element is connected in a hermetically sealed manner to the base plate and/or carrier structure by way of an integral bond. Walls of the carrier structure are oriented in the interior of the housing, on which at least one sensor unit is arranged and which each at predefined angles with respect to one another, having a maximum angular deviation of 2°, preferably no more than 1°. They comprise a smooth planar surface. The sensor units are electrically conductively connected to one another and to the outside by means of electrical conductors.

### FIELD

The invention relates to a method for producing a multidimensional inertial sensor system and to an inertial sensor system produced using the method.

### BACKGROUND

The systems thus produced can be used in the application area of three-dimensional pose and position determination under a wide variety of ambient conditions. They can be used as an alternative/redundant system (for example, in the case of satellites) when no GPS signal is available or when the ambient conditions prevent the signal transmission (deep in the mountain, under water, in narrow street canyons in urban settings, and the like), to bridge a brief failure of the standard position determination by means of GPS or star maps, when an exact position and pose determination is required for economic or legal reasons (for example, satellites, autonomous driving, underground vehicles, and the like), or they can be used as a lightweight/small system that determines the ACTUAL position on a robot head/tool, or as a system that generates and transmits the relevant data at a sufficiently high frequency in the requisite accuracy, format and quality.

Known sensor units that can be used in this field are usually produced in such a way that the sensors are fixed on printed circuit boards and contacted with electrical conductors formed on the printed circuit boards. The printed circuit boards are then arranged and mounted in a suitable shape within a housing. In the process, a wide variety of materials or substances are used in combination for the printed circuit boards and the housing. The disadvantage is that the assembly requires a very precise orientation of the sensors, which must also be maintained permanently during operation to avoid measuring errors.

This, however, presents problems, amongst others due to the differing thermal coefficients of expansion of the various materials and substances. These result in mechanical stresses during temperature changes, which, in turn, can cause deformations and mechanical damage, which can then result in measuring errors as well as leakage into the environment. As a consequence, condensation may arise in the interior, which can result in further disadvantages.

Due to the required high position and orientation accuracy of the inertial sensors, the complexity during assembly is very high. As was previously addressed, the required position and orientation accuracy can also be disadvantageously influenced by the mechanical stresses that occur during use.

Proceeding from this, it is the object of the invention to provide options that permanently allow a high position and orientation accuracy of the used sensors to be observed under a wide range of usage conditions and that also permanently allow the penetration of fluids from the surrounding area to be avoided.

### SUMMARY

According to the invention, this object is achieved by a method according to claim 1. Claim 9 relates to a sensor system produced using the method. Advantageous embodiments and refinements of the invention can be implemented with features set out in the dependent claims.

In the method according to the invention for producing a multidimensional inertial sensor system comprising a closed housing in which multiple sensor units are arranged, first a suspension is produced with at least 40 mass % of a sinterable ceramic powder and a polymer that can be cured under the influence of electromagnetic radiation, heat or cooling with at least 30 mass % in which the particles of the ceramic powder are homogeneously distributed.

Using an additive manufacturing method, first a base plate and, on the base plate, a carrier structure comprising at least two walls, which are each oriented at predefined angles, preferably perpendicularly, with respect to one another, and, parallel thereto, in another device or in a subsequently performed manufacturing step, a cover element for hermetically sealing sensor units, or the sensor units, are produced layer by layer using the suspension. Procedures and control programs that are known per se can be resorted to for the additive manufacturing process.

Hermetic shall be understood to mean a fluid-tight connection, which, in particular, can prevent moisture or other aggressive fluids from penetrating the housing so that condensation, corrosion and other harmful influences from the surrounding area can be avoided.

Thereafter, the green body formed by way of the base plate and the carrier structure as well as the cover element are subjected to a thermal treatment, during which drying, the thermal decomposition of at least substantially all contained organic components, and subsequently sintering of the ceramic powdery material are achieved. The organic residual content should be less than 3 mass %, and organic components should preferably have been completely removed.

While the additive manufacturing process is being performed or subsequent to the sintering process, electrical conductors are created at least on and/or in walls of the carrier structure using a suspension that contains electrically conducting particles and an organic binder, for the connection and the electrically conducting connection to sensor units.

Using a further thermal treatment, a drying step, the thermal decomposition of at least substantially all contained organic components, and subsequently a sintering step of the electrically conducting particles are carried out for creating electrical conductors for electrically contacting the sensor units. The organic components can be reliably thermally decomposed at temperatures up to 600° C. The sintering can be achieved for the particular ceramic material taking the selected particle size of the used powder into consideration, based on existing empirical values, by adhering to known parameters.

Thereafter, the sensor units are each attached to one of the walls of the base plate, of the carrier structure and/or the cover element, which are formed so as to be oriented at predefinable angles, preferably perpendicularly, with respect to one another, and are electrically conductively connected to the electrical conductors, before a hermetically sealed housing is created by way of the sintered cover element and the base plate and/or the walls of the carrier structure by placing the cover element onto the base plate or surfaces of walls of the carrier structure, and subsequently creating an integral bond, preferably by way of soldering, sintering, or adhesive bonding. A “soft solder” can be used for this purpose (liquidus temperature around 180 to 300° C. (standard 220 to 250° C.)), or a sinter bond using a material that sinters at relatively low temperatures (around 300° C.).

Particularly preferably, high-temperature-stable joining is performed. This can be achieved by a soldering process with a metal having a high melting point of at least 600° C., or a suitable adhesion promoter can be used. The soldering should be carried out by way of a locally defined energy input, for example by irradiation with an energy beam, preferably a laser beam, so as to avoid damage to the sensor units and the electrical conductors.

At least the walls of the carrier structure to which sensor units are being attached should be designed with an orientation that deviates by no more than 2°, preferably no more than 1°, from the predefined orientation and with a planar smooth surface, which is preferably free of elevations and depressions.

Conventional software can be employed during the layered additive manufacturing process, which takes the particular design data for the base plate, the carrier structure, and the cover element, as well as the particular device for additive manufacturing into consideration.

Advantageously, the green bodies of the base plate and carrier structure should be produced by stereolithography using vat photopolymerization, whereby very high manufacturing accuracy, in particular as regards the orientation and surface design of walls of the carrier structure on which sensor units are being installed, can be achieved, without necessitating post-processing in any form to achieve the desired position and orientation accuracy.

The green body comprising the base body and carrier structure, however, can also be produced using other additive manufacturing methods, of which examples are mentioned hereafter: screen printing, jet printing, pad printing, or stencil printing.

In this way, it is likewise advantageously possible to print a suspension comprising the respective solids particles and the organic ingredients in a defined manner so as to form the base plate, the carrier structure, and the cover element. Thereafter, a curing process can be carried out by irradiation, heating, or cooling, as a function of the organic ingredient of the suspension. When printing thermoplastic polymeric components, this is usually carried out at elevated temperatures so as to set a suitable viscosity. After the printing has been completed, cooling takes place, thereby curing the particular layer(s).

All of the individual ceramic parts, these being the base plate, the carrier structure, and the cover element, should be produced from the same ceramic material.

After the ceramic body has been produced and sintered, the functionalization is carried out in a second technological step by means of thick-film technology. In this technology, pasty materials are printed onto the surface of ceramic substrates and in a subsequent step undergo thermal processing. During this process, the paste is reacted, whereby structurally resolved functional layers are generated on the surface of the substrates.

Types of available thick-film pastes are insulating pastes, dielectric pastes, conductive pastes, and pastes for generating electrical resistances.

In a preferred alternative, electrical conductors and/or electrical plated through-holes can be created on or through walls of the base plate and/or carrier structure in thick-film technology before hermetically sealing the housing by way of the cover element. However, they can also be produced simultaneously with the additive manufacturing process in walls of the carrier structure and/or of the base plate. They can be applied during a printing method of the additive manufacturing process of the green bodies, but may also only be applied to surfaces of the carrier structure or base plate after the sintering process. During this process, known procedures of the so-called thick-film technology can be used. Electrical plated through-holes (vias) can also be filled with electrically conducting paste, thereby establishing electrically conducting connections through walls.

Electrical insulating layers can be applied to electrical conductors so as to avoid electrical short circuits. Further conductors or thick-film resistor pastes could then be processed onto these insulating layers. In this way, multi-layer structures can be created. For example, thick-film resistors that are integrated into layers can thus be formed, in particular using ruthenium oxide. When using thick-film technology, it is also possible to use suitable glass materials as adhesion promoters.

The ceramic material used can be aluminum oxide, silicon nitride, aluminum nitride, silicon carbide, porcelain, zirconium oxide, mixtures of Al₂O₃ and ZrO₂, and Cu, Al, Ag, Au, Pt, Pd or an alloy of these chemical elements can be used as the material for electrical conductors.

Suitable organic polymers for producing the suspension which is used to create the base plate, carrier structure, and cover element are, for example, (ethyl) celluloses/polyacrylates/acrylic resins/polycarbonates/polyvinyl acetals, which can be used after being dissolved in solvents/alcohols having high boiling points or in some instances also dissolved in water.

The sensor units can be connected and attached to electrical conductors in an electrically conducting manner by means of adhesive joining, soldering, sintering, welding, wire bonding or by way of flip chip technology.

The inertial sensor system is made up of a hermetically sealed housing, which is formed with a base plate, a carrier structure arranged in the interior of the housing, and a cover element, made of the same ceramic material. The cover element is hermetically joined to the base plate and/or carrier structure by way of an integral bond, preferably a soldered bond (soft solder, reaction solder, sintered bond) or adhesive bonding. Sensor units are arranged on multiple walls, wherein the planar smooth surfaces of the carrier structure in the interior of the housing, on each of which a sensor unit is arranged, are each oriented in a defined manner at predefinable angles, preferably perpendicularly with respect to one another, having a maximum angular deviation of 2°, preferably no more than 1°. In addition, the sensor units are electrically conductively connected to one another and to the outside by means of electrical conductors.

In particular, if deviations occur from the particular predefined angle or the orthogonality, but also generally speaking, a compensation or calibration of the sensor units can be carried out so as to enable a more exact position determination accuracy.

Each of the sensor units can comprise as a micromechanical sensor element, preferably as an Si-MEMS sensor unit for measuring the acceleration (accelerometer) or gravitation and rotation rate (gyroscope), and optionally for detecting the magnetic field and the signal conversion thereof by means of an application-specific integrated circuit (ASIC) or a discrete circuit.

On a sensor system according to the invention, at least one sensor unit should be arranged on each of the three walls of the carrier structure, of the cover element and/or of the base plate which are oriented at defined angles/perpendicularly with respect to one another. When a sensor unit is arranged on a base plate or on the cover element, at least two sensor units should preferably be installed on walls that are oriented perpendicularly thereto and in each case likewise perpendicularly with respect to one another.

Temperature control channels can also be formed and/or temperature control elements can also be arranged on and/or in walls of the carrier structure. An accordingly temperature-controlled fluid can flow through such channels, as needed for cooling or heating. A heating element can be arranged on sensor units, for example.

Alone or in addition, at least one temperature sensor can also preferably be arranged within the housing, which can also be utilized for regulation during the temperature control process and/or for taking the influence of the temperature on the determination results into consideration.

Electrical resistance heating elements, which are known per se and which optionally can also be formed in thick-film technology on surfaces of the carrier structure, can be utilized as temperature control elements. However, it is also possible to use Peltier elements, as an example of thermoelectric elements for cooling or heating.

Such channels or temperature control elements should preferably be arranged on walls of the carrier structure, the walls on which sensor units are arranged, or in wall regions located far away from sensor units.

Together with the temperature control channels or in addition thereto, reinforcement elements can be formed on the walls of the carrier structure, by way of which the stability can be increased and the orientation accuracy of the walls with the sensor units can be further improved. Reinforcement elements can be designed as ribs across a large portion of the length of walls.

Walls of the carrier structure can be arranged polygonally with respect to one another and preferably enclose an inner cavity. Walls can form a triangular, quadrangular or polygonal arrangement. The inner free cavity can advantageously be utilized to retain the carrier structure during the creation of electrical conductors, and optionally also for the attachment of the sensor units to the walls. The retention can then be implemented by way of a suitable contoured and dimensioned pin, which can be inserted into the cavity.

A sensor unit can be arranged on a smooth planar surface of the base plate and/or of the cover element. In this case, at least two further sensor units should be arranged on a respective wall of the carrier structure which is oriented at a predefined angle thereto.

In a simple embodiment, a cover element can likewise be a plate, which is placed onto outwardly facing surfaces of walls of the carrier structure and is integrally bonded to the carrier structure there. The housing is then formed by way of the base plate, walls of the carrier structure, and the cover element.

However, it is also an option for a cover element to be used that is designed in one piece in the shape of a cap that can be put over a carrier structure and placed with end faces on a surface of the base plate on which the integral bond is being formed. The housing is then formed by way of the base plate and the cover element. The carrier structure is then encased in the housing. If appropriately dimensioned, the carrier structure is then positioned freely in the housing. In this way, sensor units can also be arranged on outwardly facing surfaces of walls of the carrier structure, which can be capitalized on in order to have a facilitating effect for the installation of the sensor units and the creation of the electrical conductors.

The electrical conductors or an attachment and a closure of the cover element by means of a soldered bond permanently ensure the orientation of the electrical/electronic components and the protection thereof against environmental conditions. By directly applying or creating electrical conductors on ceramic substrates that have a similar thermal coefficient of expansion, such as Si-based components, the number of materials used, and accordingly the thermally induced mechanical stresses, can be reduced. By integrating and coupling all inertial sensor units in one system, mass and space for the individual housings can be saved, whereby the overall system can be miniaturized. Moreover, the number of materials and the influence of the temperature are reduced. The combination of flexible manufacturing technologies (AM and thick-film technology) allows application-specific geometries to be implemented.

By means of the manufacturing process chain that is used, it is possible to achieve both the implementation of cooling channels or targeted enhancement or lessening of the heat transfer in the individual directions as a result of the additive manufacturing of the ceramic structures, and the implementation of temperature sensors, heaters, Peltier elements (for heating or cooling) and the like for actively controlling the temperature of the sensor system.

Moreover, the additive manufacturing process makes it possible to implement freeform geometries, which allow the geometry of the sensor system to be optimally adapted to the available installation space, wherein the functionalization with the electrical and electrical components can then possibly take place using alternative thick-film technologies (for example, aerosol printing instead of screen printing, with pad printing and ink jet printing also being conceivable).

The ceramic structures that can be utilized according to the invention, in combination with the directly applied electrical conductors, not only provide the functionality of a printed circuit board and of a robust ceramic housing, but as a result of the 3D structures also permanently ensure the defined orientation of the sensor elements. Through the use of flexible manufacturing technologies, the outer and inner geometries and dimensioning can be flexibly adapted to the geometries of the surrounding elements/structures, and geometric structures and additional materials can be integrated for actively controlling the temperature of the sensor system.

### DESCRIPTION OF THE FIGURES

The invention will be described in more detail hereafter by way of example.

In the drawings:

FIG. 1 shows an example of a base plate in a perspective manner;

FIG. 2 shows an example of carrier structures usable for the invention in a perspective illustration; and

FIG. 3 shows an example of a cover element in a perspective illustration.

### DETAILED DESCRIPTION

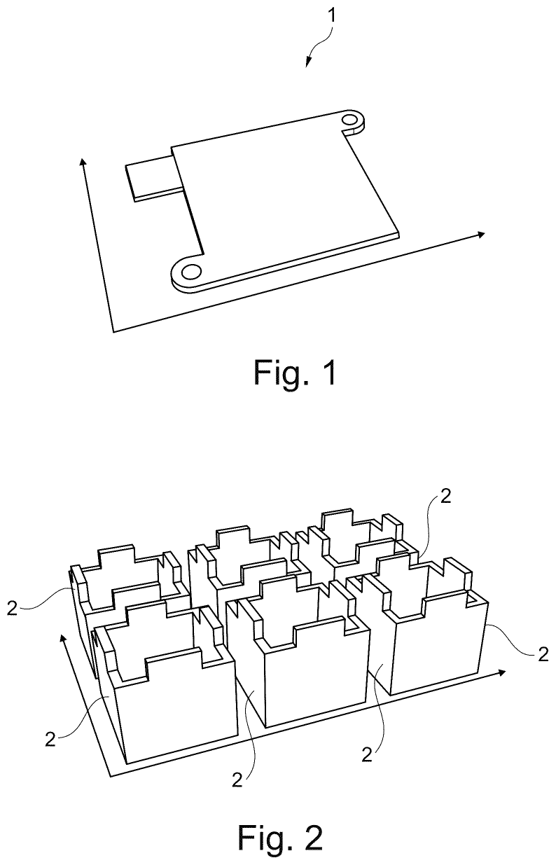

The example shown in FIG. 1 shows a base plate 1 having a smooth planar surface, which can be produced layer by layer from a ceramic material in an additive manufacturing process, as was previously addressed and for which further manufacturing examples will be described in greater detail hereafter. Electrical conductors can be created in a shape that is not shown on the upwardly facing surface of the base plate 1, to which at least one sensor unit can also be electrically conductively connected and arranged on the base plate, preferably before the housing is closed by way of the cover element 3.

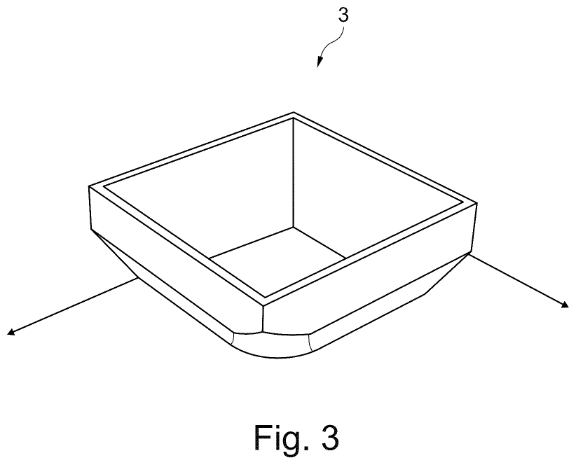

FIG. 2 shows multiple carrier structures 2, the vertically oriented walls of which can be used as carriers for electrical conductors and sensor units. The carrier structures 2 have been built on the base plate 1 and form a single part. Using the same process as the base plate 1, they are built directly thereon. Electrical conductors, which are not apparent here, can be created on or in the walls and can be connected to sensor units.

There is also the option of producing multiple carrier structures 2 on a base plate 1 and of subsequently cutting the initial base plate into multiple individual parts using a cutting process, which can then be utilized individually to produce multiple sensor systems.

However, it is also an option to manufacture base plates 1 and carrier structures 2 separately. This, however, should be carried out using the same ceramic material, and preferably also using the same manufacturing method. After the separate manufacture has been carried out, a functionalization and population can be performed. When proceeding in this way, these activities are facilitated since the accessibility is improved. It is also possible to select simpler geometries for the individual elements forming a system. Base plates 1 and carrier structures 2 can be joined after having been manufactured. For this purpose, receptacles for a carrier structure 2 can be formed in the base plates 1 during the manufacture thereof, which can be used to support exact positioning with respect to one another. This procedure facilitates the functionalization and population with the sensor units given the limited available material combinations.

In general, it is also possible to provide multiple carrier structures 2 on a base plate 1, whereby a sufficiently large installation space can be created for the population with sensor units and the creation of electrical conductors.

FIG. 3 shows an example of a cover element 3, which has a cap shape here. This cover element 3 can be placed on a completed semi-finished product, which is formed by way of a base plate 1 and a carrier structure 2 made of ceramic sintered material and populated with at least one, preferably at least three sensor units, wherein the opening of the cap-shaped cover element 3 faces toward the base plate 1. The surfaces of the base plate 1 and of the end wall of the cover element 3 making contact with one another can then be integrally bonded to one another in a hermetically sealed manner, preferably by soldering. The cover element 3 should be made of the same ceramic sintered material as the base plate 1 and carrier structure 2.

One can proceed, for example, as follows.

Prior to the actual production, the components must be designed and generated in the virtual space using design software (such as Solid Works, FreeCad, AutoCAD, Rhino and the like).

After the control data for the additive manufacturing (CAD) has been generated, the planning of the production by means of additive manufacturing is carried out, here preferably using the CerAM VPP (vat photopolymerization) technology. The equipment software corresponding to the design is loaded into the manufacturing equipment, and manufacturing can then be started to produce green bodies of the three components, these being the base plate, the carrier structure, and the cover element. For the production, a CeraFab 8500 machine, which is sold commercially by Lithoz, can be used.

So as to achieve optimal production and utilization of the manufacturing equipment, the orientation of the green bodies for the components to be produced in the installation space should be planned. Using the controller, the production/printing parameters (for example, vat rotation, dumping, tilting back, build layer thickness, exposure energy, material application and the like) can be set for the particular material that is used. Depending on the build layer thickness, the individual components are broken down into layers (slices) in an appropriate layer count for the additive manufacturing of the green bodies.

Prior to the actual start of the additive manufacturing, the particular suspension, for example a photoreactive aluminum oxide suspension, should be made available, in which a homogeneous distribution of the individual components has been achieved. Photoreactive resins (monomers and oligomers), such as acrylates, methacrylates, epoxyacrylates and the like, can be kept available as organic ingredients in a defined quantity in a vessel suitable for the preparation process. It is possible to add further additives, such as reactive diluents, rheology additives, plasticizing fluids, initiators (matched to the wavelength of the AM equipment used), and surface-modifying substances such as dispersants (liquefiers for the Al₂O₃ powder).

For homogenization, the components are carefully mixed (for example, Dispermat, planetary ball mixer, high-speed mixer, and the like). Aluminum oxide powder is added to the organic viscous components in the appropriate quantity, in particular in the range of 50 mass % to 85 mass % or 35 vol % to 65 vol %. The dispersion and homogenization of the aluminum oxide powder in the polymer formulation can be achieved by means of a preparation unit (for example, Dispermat, planetary ball mixer, high-speed mixer, and the like) so as to achieve the homogeneous and complete deagglomeration of the powder particles/granules for a narrow distribution.

The preparation can be carried out in multiple stages (defined duration up to 2 hours), depending on the unit, with intermediate cooling. After the preparation process, necessary preparation aids (possibly used grinding balls) can be removed and present air can be eliminated by evacuation. Moreover, a characterization of the rheological and photoreactive properties can be carried out for quality control purposes.

The shaping can be carried out as follows using CerAM VPP (vat photopolymerization):

Preparatory steps during the additive manufacturing are: inserting build platform, preparing vat, initializing squeegee, loading the control software for the green bodies to be produced into the manufacturing equipment, adding the previously produced suspension or inserting a suspension-containing material cartridge for automated material supply, setting and optimizing the squeegee parameters for optimal suspension application for the generation of homogeneous layers.

Then the build process can start. During a print test, the build platform is lowered into the vat and enters the suspension, with the orientation (parallelism) being checked in the process. The build platform is then moved upwardly in the z direction, whereby new suspension is homogeneously applied. Thereafter, the build platform is lowered back into the vat. An initial layer is then formed on the build platform (backside illuminated layer) in the form of a full surface area, which as a result of exposure, polymerization and solidification of the exposed area by means of locally defined irradiation with electromagnetic radiation that is suitable for photopolymerization causes a layer made of the solidified material to be obtained in the irradiated areas of this layer. The build platform is then moved upwardly in the z direction, and new suspension is homogeneously applied by way of the squeegee, whereupon the build platform is moved back into the vat, offset upwardly by the thickness of the respective build layer thickness. The first build layer is likewise generated by irradiating the corresponding areas in the build field from beneath with suitable electromagnetic radiation, preferably using a digital light processing (DLP) module, through the vat which allows electromagnetic radiation to pass, for example is made of glass, for a spatially resolved polymerization of the corresponding photopolymer of the suspension (only in exposed areas). Then the vat is dumped for gentle decontacting of the formed layer from the vat. Thereafter, the build platform is moved upwardly in the z direction after each layer of a green body to be produced has been formed, and new suspension is homogeneously applied. Thereafter, a defined number of further starting layers is successively formed (variable parameter, standard=5 starting layers) according to the above-described pattern with parameters set for this purpose, until all layers that are required for the green bodies to be produced have been formed. The individual successively formed and irradiated layers then form the base plate and, on the base plate, the carrier structure as well as the cover element, as a function of the contour or surface areas formed by the locally defined irradiation.

The build job is completed after the last component layer has been manufactured, and the process can transition to the cleaning operation.

Parameters used for shaping by means of CerAM VPP on CeraFab 8500 from Lithoz:
Squeegee blade angle of inclination for forming layers: 0-2°, preferably 0.6°
Squeegee blade angle of inclination for scraping: 0-2°, preferably 0.6°
Squeegee setting angle: 44°-48°, preferably 45.5°
Rotation of the squeegee: 1 time to 10 times, preferably 2 times
Rotational speed: 20°/s-360°/s, preferably 200° /s
Settling time: 0-600 s, preferably 8 s
Raising speed in z direction: 0.1°/s-50°/s, preferably 8°/s
Exposure time: 0-15 s, preferably 1.2 s
Energy of the electromagnetic radiation: 5-1000 mJ/cm², preferably 140 mJ/cm²
Intensity of the electromagnetic radiation: 0.5-56.6 mW/cm², preferably 56.6 mW/cm²
Lowering speed 01, −50°/s, preferably 8°/s.

For post-processing, the manufactured components can be feed of adhering suspension and cleaned as best as possible in multiple steps using a special cleaning solution combined with compressed air. The quality of the final product depends significantly on the cleaning process. This should be performed with utmost care so as not to damage green bodies. It is then possible to carefully remove the produced green bodies from the build platform, for example by means of a knife. During the quality control of the green bodies, the surface finish, the completeness and build defects, as well as the dimensions in all spatial directions should be taken into consideration.

Prior to the debinding step for the removal of organic components, a pre-conditioning step can then be carried out, during which a baking-out of the green bodies up to 120° C. is carried out for several hours (a minimum of 12 hours to a maximum of 72 hours) for post-crosslinking areas that were not fully cross-linked and for removing possibly employed highly volatile components from the green bodies as well as the cleaning solution used.

Produced green body substrates can then be baked out up to a minimum of 600° C. in accordance with a temperature-time profile that is as precisely defined as possible so as to remove the organic components, which are necessary for the production process and serve as binding agents between the particles. The heating can also be carried out up to 1100° C. for aluminum oxide so as to achieve pre-solidification, so that a possibly required transfer into the sintering furnace comes with a lower risk of defects for the subsequent step.

During the debinding step, the organic ingredients are completely thermally decomposed and discharged in gaseous form.

During a pre-conditioning step over 72 hours at 120° C. and at a starting temperature of 25° C., the following parameters can be adhered to:
1 h 15 min at a heating rate of 0.2 K/min to a temperature of 90° C. with a holding time of 5 h
1 h 40 min at a heating rate of 0.2 K/min to a temperature of 110° C. with a holding time of 5 h
50 min at a heating rate of 0.2 K/min to a temperature of 120° C. with a holding time of 38 h
6 h at a heating rate of 0.25 K/min to a temperature of 30° C. with a holding time of 0

Temperature regimen for debinding:
heating time 3 h 10 min, heating rate 0.5 K/min, temperature 120° C., holding time 1 h
heating time 1 h 40 min, heating rate 0.1 K/min, temperature 130° C., holding time 3 h
heating time 6 h 40 min, heating rate 0.1 K/min, temperature 170° C., holding time 3 h
heating time 8 h 20 min, heating rate 0.1 K/min, temperature 220° C., holding time 4 h
heating time 2 h 30 min, heating rate 0.2 K/min, temperature 250° C., holding time 5 h
heating time 6 h 15 min, heating rate 0.2 K/min, temperature 325° C., holding time 5 h
heating time 3 h 30 min, heating rate 0.5 K/min, temperature 430° C., holding time 2 h
heating time 11 h 10 min, heating rate 1 K/min, temperature 1100° C., holding time 1 h
heating time 3 h 10 min, heating rate 0.5 K/min, temperature 120° C., holding time 1 h
heating time 3 h 10 min, heating rate 0.5 K/min, temperature 120° C., holding time 1 h

This is followed by the cooling step at a cooling rate of 3 K/min

Debinded substrate bodies (brown bodies) can be transferred into a sintering furnace if necessary. The sintering process can be carried out according to a defined temperature-time profile, for example for the aluminum oxide up to a maximum sintering temperature of 1600° C. to 1700° C. In the process, various heating rates and holding times can be adhered to so as to optimally compact the aluminum oxide material (sinter density min. 98% and higher) and generate a homogeneous dense structure having high performance, so that the sintered aluminum oxide has the best possible properties with respect to the surface and strength.

Temperature regimen for sintering:
heating time 1 h, heating rate 2.9 K/min, temperature 200° C.
heating time 10 h, heating rate 0.67 K/min, temperature 600° C.
heating time 6 h, heating rate 1.53 K/min, temperature 1150° C.
heating time 9 h 30 min, heating rate 0.88 K/min, temperature 1650° C., holding time 2 h
heating time 9 h, heating rate-0.83 K/min, temperature 1200° C.
heating time 1 h 28 min, heating rate-1.83 K/min, temperature 50° C.

As an alternative, the production can also be carried out by parallel processing multiple materials using additive manufacturing. During this process, both the ceramic substrate material and the electrically conductive materials can be processed to form the green body. Thereafter, a thermal processing step (debinding and sintering) must be carried out. When it comes to selecting potential material combinations, the materials to be combined should have comparable thermal coefficients of expansion as well as a comparable shrinkage behavior during the sintering process, as well as suitable viscosities for the particular manufacturing method. Possible material combinations are, for example, glass-bound low sintering ceramics (LTCC) and Ag, electrically conductive and insulating mixtures based on Si₃N₄-MoSi₂-SiC as well as glass without and with electrically conductive particles (for example graphite).

These materials can be processed both by way of CerAM VPP and by way of CerAM MMJ (multi material jetting) or CerAM FFF (fused filament fabrication). For this purpose, the materials first have to be converted into feedstock suitable for the particular AM method (photopolymerizable suspension or thermoplastic suspension or thermoplastic filament). Thereafter, the shaping step is carried out, during which the electrically conductive materials can also be “buried” within the substrate material. During the co-debinding step, purely thermal debinding (CerAM VPP and CerAM MMJ) or a combination of solvent debinding and thermal debinding (CerAM FFF) can be employed.

During a quality inspection, a check of the dimensions in all spatial directions and the quality of the sinter structure, a check with respect to the shape and surface quality, and possibly a characterization for the quality inspection (for example, density analysis, CT, 3D scan, and the like) can be carried out.

During a possibly required post-processing step, a dimensional and shape correction as well as an enhancement of the surface finish (grinding and polishing) can subsequently be carried out, if necessary.

In turn subsequent thereto, this may possibly be followed by the creation of electrical conductors, possibly subsequent to a further cleaning step.

For this purpose, electrical plated through-holes (vias) can be created using through-plating pastes that are known per se, which have an increased solids content of typically Ag, AgPt, AgPd or Pt, through walls of the carrier structure, the base plate, and, if necessary, also through the cover element. The creation can be carried out by way of stencil printing.

Electrical conductors can likewise be created on the carrier structure, and possibly the base plate, in thick-film technology by way of printing. For this purpose, a wide variety of printing methods can be utilized, in particular screen printing, stencil printing, block printing, jetting printing, or aerosol printing. After printing, the pastes containing metal particles can be dried. At 150° C., the drying of the pastes can be achieved over a period of 15 minutes to 20 minutes.

Subsequent to the drying process, the organic components of the pastes that are used are removed and sintering of the metallic ingredients is achieved. The temperature can be increased further until the sintering temperature of the metallic solids has been reached. In the case of Ag or Ag-containing pastes, 850° C. to 950° C. should be adhered to, and in the case of Pt-containing pastes, slightly higher temperatures of 950° C. to 1300° C. should be adhered to. The particular maximum temperature should be maintained over approximately 10 minutes.

Thereafter, an at least single-layer insulating layer can be applied so as to avoid electrical short circuits. An electrically insulating paste can also be printed on in one layer or multiple layers for this purpose, preferably by means of screen printing. After the individual layers have been applied, drying should be carried out at approximately 150° C. over 15 minutes to 20 minutes. This may be followed by the “burning-in” of the paste. In the event that the pastes used for electrical insulation layers contain electrically non-conducting ingredients, such as, in particular, ceramic particles, the baking can be carried out at accordingly high temperatures. For known pastes that are used for insulation purposes, this is typically 500° C. to 850° C.

In principle, there is also the option of the layer thickness reinforcement in the case of contact surfaces that are soldered, bonded or subject to high mechanical stresses (solder pads, bond pads, contact pads). For this purpose, a covering with a firing temperature at 850° C. must be used. In this case, conductive paste is repeatedly applied to the corresponding surface areas (in each case, there is again printing, drying, baking). As a result of this pad reinforcement, an increase in the layer thickness can be achieved in the pad area. This may be necessary, for example, when a thick wire having a diameter of 500 μm is to be bonded in the case of an electrical conductor track having a thickness of 10 μm since this possibly may not work due to the layer being too thin. A solution is to reinforce (thicken) the layer thickness of a bond pad. This applies similarly to soldering. Electrical conductor tracks are generally made of silver. The silver, however, may break down in the solder (dissolve) during soft soldering. For this reason, Pt or Pd is added to these pastes to increase the eutectic bonding strength. At this point, the pad can also be reinforced with respect to the layer thickness.

The ceramic parts thus prepared can then be populated with the sensor units and connected to the created electrical conductors.

After the functionalized ceramic substrates have been populated, microcontrollers, capacitors, resistors, the voltage reference, oscillators, LEDs, the acceleration sensor ASIC and the like can be applied, for example by means of reflow soldering, and be electrically contacted. After the electrical connection has been established, an electrical and functional test of the circuits can be carried out without sensor components. Thereafter, for example, Si-MEMS sensor components and rotation raw sensor (=gyroscope) ASICs can be adhesively attached, and the adhesive can then be cured. MEMS sensor components and ASICs can also be applied/mounted using bonding technologies, such as flip chip technology. Application by soldering, adhesive bonding or sinter mounting is likewise conceivable. In this case, the electrical contacting takes place directly. Conventionally, electrical contacting takes place by wire bonding methods. The MEMS components and the ASIC can advantageously at least partly under go a redesign for the contact connections.

After the creation of the electrical conductors and the population with the sensor units, the hermetic seal with the cover element can be established by way of an integral bond, as described above.

What is claimed is:

1. A method for producing a multidimensional inertial sensor system comprising a closed housing in which a plurality of sensor units are arranged, wherein
a suspension is produced with at least 40 mass % of a sinterable ceramic powder and a polymer that can be cured under the influence of electromagnetic radiation, heat or cooling with at least 30 mass % in which the particles of the ceramic powder are homogeneously distributed; and
using an additive manufacturing method, first a base plate and, on the base plate, a carrier structure comprising at least two walls, which are each oriented at predefined angles with respect to one another, and, parallel thereto, in another device or in a subsequently performed manufacturing step, a cover element for hermetically sealing the sensor units are produced layer by layer using this suspension; and
thereafter, the green bodies formed by way of the base plate including the carrier structure and the cover element are subjected to a thermal treatment, during which drying, the thermal decomposition of substantially all contained organic components, and subsequently sintering of the ceramic powdery material are achieved; and
while the additive manufacturing process is being performed and/or subsequent to the sintering process, electrical conductors are created at least on and/or in walls of the carrier structure, the base plate or the cover element using a suspension that contains electrically conducting particles and an organic binder, for the connection and the electrically conducting connection to sensor units, and, using a further thermal treatment, a drying step, the thermal decomposition of at least substantially all contained organic components, and subsequently a sintering step of the electrically conducting particles are carried out for creating electrical conductors for electrically contacting the sensor units; and
thereafter, the sensor units are each attached to one of the walls of the base plate, the carrier structure or the cover element, which are formed so as to be oriented at predefinable angles with respect to one another, and are electrically conductively contacted with the electrical conductors, before
a hermetically sealed housing is created by way of the sintered cover element and the base plate and/or the walls of the carrier structure by placing the cover element onto the base plate or surfaces of walls of the carrier structure, and subsequently creating an integral bond.

2. The method according to claim 1, characterized in that at least the smooth planar surfaces of the base plate, cover element and carrier structure, to which sensor units are being attached, deviate no more than 2°, from the predefined orientation with respect to one another.

3. The method according to claim 2, characterized in that at least the smooth planar surfaces of the base plate, cover element and carrier structure, to which sensor units are being attached, deviate no more than 1° from the predefined orientation with respect to one another.

4. The method according to claim 1, characterized in that the green body comprising the base plate and the carrier structure is produced by stereolithography using vat photopolymerization.

5. The method according to claim 1, characterized in that the green body or the green bodies for the base plate including the carrier structure and/or the cover element is or are produced by means of screen printing, jet printing, pad printing, or stencil printing.

6. The method according to claim 1, characterized in that electrical conductors and/or electrical plated through-holes are created on or through walls of the base plate and/or carrier structure in thick-film technology before hermetically sealing the housing by way of the cover element.

7. The method according to claim 1, characterized in that the ceramic material used is aluminum oxide, silicon nitride, aluminum nitride, or silicon carbide, and that Ag, Au, Pt, Pd, W, or an alloy of these chemical elements is used as the material for electrical conductors.

8. The method according to claim 1, characterized in that the sensor units are connected and attached to electrical conductors in an electrically conducting manner by means of wire bonding or by way of flip chip technology.

9. The method according to claim 1, characterized in that the integral bond between the cover element and the base plate or surfaces of walls of the carrier structure is created by means of soldering or adhesive bonding.

10. A sensor system produced using a method according to claim 1, characterized in that the sensor system is made up of a hermetically sealed housing, which is formed with the base plate, the carrier structure arranged in the interior of the housing, and the cover element, made of the same ceramic material, one or more sensor units being arranged in each case on a plurality of walls of the carrier structure, the base plate and/or the cover element, and the cover element being connected in a hermetically sealed manner to the base plate and/or carrier structure by way of an integral bond;
walls of the carrier structure in the interior of the housing, on which at least one sensor unit is arranged and which are each oriented at predefined angles with respect to one another, having a maximum angular deviation of 2° and have a planar surface; and
the sensor units being electrically conductively connected to one another and to the outside by means of electrical conductors.

11. The sensor system according to claim 10, characterized in that walls of the carrier structure in the interior of the housing, on which at least one sensor unit is arranged and which are each oriented at predefined angles with respect to one another, having a maximum angular deviation of 1° and have a planar surface connected to one another and to the outside by means of electrical conductors.

12. The sensor system according to claim 10, characterized in that each sensor unit comprises at least one micromechanical sensor element for measuring the acceleration, the rotation rate or the magnetic field and the signal conversion thereof by means of an application-specific integrated circuit or a discrete circuit.

13. The sensor system according to claim 10, characterized in that at least one sensor unit is arranged at each of the walls of the carrier structure, the cover element and/or the base plate which are oriented at predefinable defined angles with respect to one another.

14. The sensor system according to claim 10, characterized in that temperature control channels are formed and/or temperature control elements and/or at least one temperature sensor are arranged on and/or in the walls of the carrier structure and/or the base plate.

15. The sensor system according to claim 10, characterized in that walls of the carrier structure are arranged polygonally with respect to one another.

16. The sensor system according to claim 15, characterized in that walls of the carrier structure are enclose an inner cavity.

17. The sensor system according to claim 14, characterized in that at least one of the sensor units comprises an additional heating element.

18. The sensor system according to claim 10, characterized in that the sensor units are designed as Si-MEMS sensor units.

19. The sensor system according to claim 10, characterized in that the walls on which sensor units are arranged are oriented perpendicularly with respect to one another, and at least two walls are oriented perpendicularly with respect to one another and with respect to the base plate or an inner wall of the cover element.
